(19) United States
(12) Patent Application Publication
(10) Pub. No.: US 2017/0365249 A1
(43) Pub. Date: Dec. 21, 2017

(54) SYSTEM AND METHOD OF PERFORMING AUTOMATIC SPEECH RECOGNITION USING END-POINTING MARKERS GENERATED USING ACCELEROMETER-BASED VOICE ACTIVITY DETECTOR

(71) Applicant: Apple Inc., Cupertino, CA (US)

(72) Inventors: Sorin V. Dusan, San Jose, CA (US); Devang K. Naik, San Jose, CA (US); Sachin S. Kajarekar, Sunnyvale, CA (US)

(21) Appl. No.: 15/188,861

(22) Filed: Jun. 21, 2016

(51) Int. Cl. G10L 15/05; G10L 21/0208; G10L 15/30; G10L 25/21; H04R 1/10

(52) U.S. Cl. CPC G10L 15/05; G10L 25/21; H04R 1/1016; G10L 15/30; G10L 21/0208; H04R 2420/07

(57) ABSTRACT

A method of performing automatic speech recognition (ASR) using end-pointing markers generated using accelerometer-based voice activity detector starts with a voice activity detector (VAD) generating an accelerometer VAD output (VADa) based on data output by at least one accelerometer that is included in at least one earbud. The at least one accelerometer to detect vibration of the user's vocal chords. A voice processor detects a speech signal based on acoustic signals from at least one microphone. An end-pointer generates the end-pointing markers based on the VADa output and an ASR engine performs ASR on the speech signal based on the end-pointing markers. Other embodiments are also described.

### FIELD

Embodiments of the present disclosure relate generally to a system and method for performing automatic speech recognition (ASR) using end-pointing markers generated using an accelerometer-based voice activity detector.

### BACKGROUND

Currently, a number of consumer electronic devices are adapted to receive speech via microphone ports or headsets. While the typical example is a portable telecommunications device (mobile telephone), with the advent of Voice over IP (VoIP), desktop computers, laptop computers, and tablet computers may also be used to perform voice communications.

When using these electronic devices, the user also has the option of using the speakerphone mode or a wired headset to receive his speech. However, a common complaint with these hands-free modes of operation is that the speech captured by the microphone port or the headset includes environmental noise, such as wind noise, secondary speakers in the background, or other background noises. This environmental noise often renders the user's speech unintelligible and thus, degrades the quality of the voice communication.

When performing speech recognition, the electronic device may be assessing the speech captured by the microphone port or headset that may come from secondary speakers in the background in addition to speech coming from the electronic device's primary user (or speaker).

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates an example of the headset in use according to one embodiment.

FIG. 2 illustrates an example of the right side of the headset used with a consumer electronic device in which an embodiment may be implemented.

FIG. 3 illustrates a block diagram of a system for performing ASR using end-pointing markers generated using an accelerometer-based voice activity detector according to an embodiment.

FIG. 4 illustrates a block diagram of the details of the voice processor included in the system in FIGS. 3 and 5-7 for performing ASR using end-pointing markers generated using an accelerometer-based voice activity detector according to one embodiment.

FIG. 5A and 5B illustrate block diagrams of systems for performing ASR using end-pointing markers generated using an accelerometer-based voice activity detector according to some embodiments.

FIG. 6 illustrates a block diagram of a system for performing ASR using end-pointing markers generated using an accelerometer-based voice activity detector according to an embodiment.

FIG. 7 illustrates a block diagram of a system for performing ASR using end-pointing markers generated using an accelerometer-based voice activity detector according to an embodiment.

FIG. 8 illustrates a flow diagram of an example method ASR using end-pointing markers generated using an accelerometer-based voice activity detector according to one embodiment.

FIG. 9 is a block diagram of exemplary components of a mobile device included in the system in FIGS. 3 and 5-7 for performing ASR using end-pointing markers generated using an accelerometer-based voice activity detector in accordance with aspects of the present disclosure.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

The present disclosure relates generally to systems and methods for performing ASR using end-pointing markers generated using an accelerometer-based voice activity detector. In one example system, at least one accelerometer is included in at least one earbud to detect vibration of the user's vocal chords. The at least one accelerometer is used to generate data output that is used by an accelerometer-based voice activity detector (VADa) to generate a VADa output. The VADa is a more robust voice activity detector that is less affected by ambient acoustic noise. Accordingly, the VADa may more accurately detect speech by the primary speaker rather than speech from a secondary speaker in the background. The VADa output is then used to perform the ASR on the acoustic signals received from at least one microphone that may be included in at least one earbud.

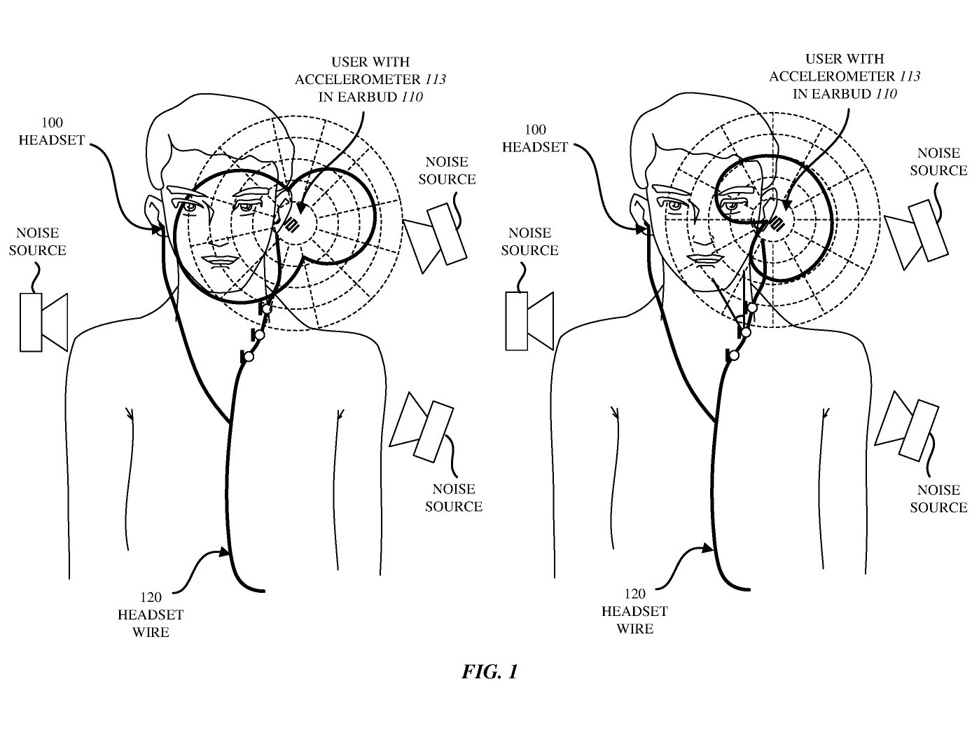

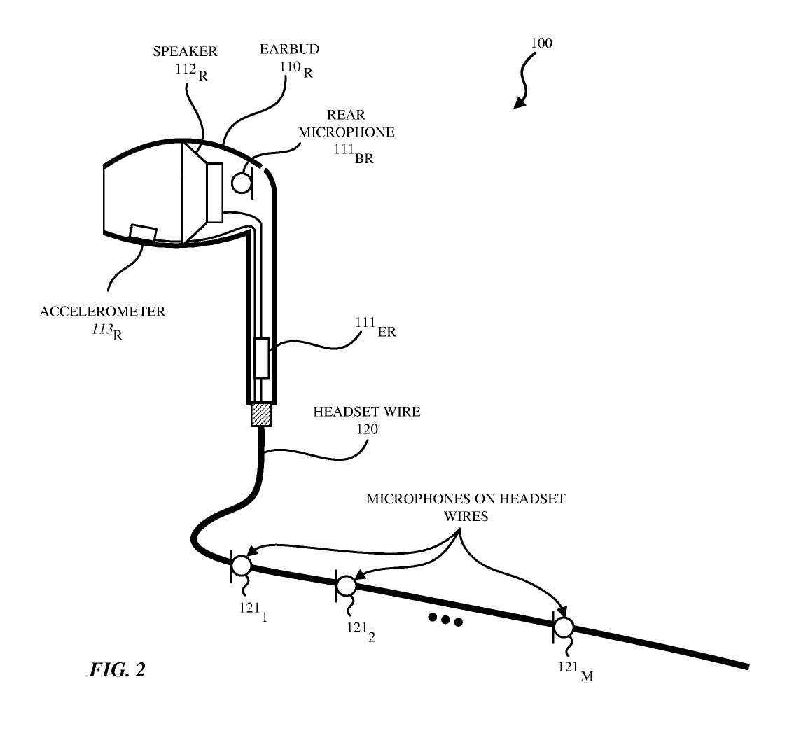

FIG. 1 illustrates an example of a headset in use that may be coupled with a consumer electronic device 10 (not shown) according to one embodiment. As shown in FIGS. 1 and 2, the headset 100 includes a pair of earbuds 110 and a headset wire 120. The user may place one or both the earbuds into his ears and the microphones in the headset 100 may receive his speech. The microphones may be air interface sound pickup devices that convert sound into an electrical signal. The headset 100 in FIG. 1 is shown as a double-earpiece headset. It is understood that single-earpiece or monaural headsets may also be used. As the user is using the headset to transmit his speech, environmental noise may also be present (e.g., noise sources in FIG. 1). While the headset 100 in FIG. 2 is an in-ear type of headset that includes a pair of earbuds 110 which are placed inside the user's ears, respectively, it is understood that headsets that include a pair of earcups that are placed over the user's ears may also be used. Additionally, embodiments of the present disclosure may also use other types of headsets. Further, while FIG. 1 includes a headset wire 120, in some embodiments, the earbuds 110 may be wireless and communicate with each other and with the electronic device 10 via BlueTooth™ signals. Thus, the earbuds may not be connected with wires to the electronic device 10 (not shown) or between them, but communicate with each other to deliver the uplink (or recording) function and the downlink (or playback) function.

FIG. 2 illustrates an example of the right side of the headset used with a consumer electronic device in which an embodiment of the present disclosure may be implemented. It is understood that a similar configuration may be included in the left side of the headset 100. As shown in FIG. 2, the earbud 110_{R} includes a speaker 112_{R}, an inertial sensor detecting movement, such as an accelerometer 113_{R}, a rear (or back) microphone 111_{BR} that faces the opposite direction of the eardrum, and an end microphone 111_{ER} that is located in the end portion of the earbud 110_{R} where it is the closest microphone to the user's mouth. The earbud 110_{R} may also be coupled to the headset wire 120, which may include a plurality of microphones 121₁-121_{M} (M>1) distributed along the headset wire that can form one or more microphone arrays. As shown in FIG. 1, the microphone arrays in the headset wire 120 may be used to create microphone array beams (e.g., beamformers) which can be steered to a given direction by emphasizing and deemphasizing selected microphones 121₁-121_{M}. Similarly, the microphone arrays can also exhibit or provide nulls in other given directions. Accordingly, the beamforming process, also referred to as spatial filtering, may be a signal processing technique using the microphone array for directional sound reception. The headset 100 may also include one or more integrated circuits and a jack to connect the headset 100 to the electronic device 10 (not shown) using digital signals, which may be sampled and quantized.

In one embodiment, each of the earbuds 110_{L}, 110_{R} is a wireless earbud and may also include a battery device, a processor, and a communication interface (not shown). In this embodiment, the processor may be a digital signal processing chip that processes the acoustic signal from at least one of the microphones 111_{BR}, 111_{ER} and the inertial sensor output from the accelerometer 113_{R}. In one embodiment, the beamformers' patterns illustrated in FIG. 1 are formed using the rear microphone 111_{BR} and the end microphone 111_{ER} to capture the user's speech (left pattern) and to capture the ambient noise (right pattern), respectively.

The communication interface may include a Bluetooth™ receiver and transmitter to communicate acoustic signals from the microphones 111_{BR}, 111_{ER}, and the inertial sensor output from the accelerometer 113_{R} wirelessly in both directions (uplink and downlink) with the electronic device. In some embodiments, the communication interface communicates encoded signal from a speech codec 160 to the electronic device 10.

When the user speaks, his speech signals may include voiced speech and unvoiced speech. Voiced speech is speech that is generated with excitation or vibration of the user's vocal chords. In contrast, unvoiced speech is speech that is generated without excitation of the user's vocal chords. For example, unvoiced speech sounds include /s/, /sh/, /f/, etc. Accordingly, in some embodiments, both the types of speech (voiced and unvoiced) are detected in order to generate an augmented voice activity detector (VAD) output, which more faithfully represents the user's speech.

First, in order to detect the user's voiced speech, in one embodiment, the output data signal from accelerometer 113 placed in each earbud 110 together with the signals from the microphones 111_{B}, 111_{E} or the microphone array 121₁-121_{M} or the beamformer may be used. The accelerometer 113 may be a sensing device that measures proper acceleration in three directions, X, Y, and Z or in only one or two directions. When the user is generating voiced speech, the vibrations of the user's vocal chords are filtered by the vocal tract and cause vibrations in the bones of the user's head which are detected by the accelerometer 113 in the headset 110. In other embodiments, an inertial sensor, a force sensor or a position, orientation and movement sensor may be used in lieu of the accelerometer 113 in the headset 110.

In the embodiment with the accelerometer 113, the accelerometer 113 is used to detect the low frequencies since the low frequencies include the user's voiced speech signals. For example, the accelerometer 113 may be tuned such that it is sensitive to the frequency band range that is below 2000 Hz. In one embodiment, the signals below 60 Hz-70 Hz may be filtered out using a high-pass filter and above 2000 Hz-3000 Hz may be filtered out using a low-pass filter. In one embodiment, the sampling rate of the accelerometer may be 2000 Hz but in other embodiments, the sampling rate may be between 2000 Hz and 6000 Hz. In another embodiment, the accelerometer 113 may be tuned to a frequency band range under 1000 Hz. It is understood that the dynamic range may be optimized to provide more resolution within a forced range that is expected to be produced by the bone conduction effect in the headset 100. Based on the outputs of the accelerometer 113, an accelerometer-based VAD output (VADa) may be generated, which indicates whether or not the accelerometer 113 detected speech generated by the vibrations of the vocal chords. In one embodiment, the power or energy level of the outputs of the accelerometer 113 is assessed to determine whether the vibration of the vocal chords is detected. The power may be compared to a threshold level that indicates the vibrations are found in the outputs of the accelerometer 113. In another embodiment, the VADa signal indicating voiced speech is computed using the normalized cross-correlation between any pair of the accelerometer signals (e.g., X and Y, X and Z, or Y and Z). If the cross-correlation has values exceeding a threshold within a short delay interval the VADa indicates that the voiced speech is detected. In some embodiments, the VADa is a binary output that is generated as a voice activity detector (VAD), wherein 1 indicates that the vibrations of the vocal chords have been detected and 0 indicates that no vibrations of the vocal chords have been detected.

Using at least one of the microphones in the headset 110 (e.g., one of the microphones in the microphone array 121₁-121_{M}, back earbud microphone 111_{B}, or end earbud microphone 111_{E}) or the output of a beamformer, a microphone-based VAD output (VADm) may be generated by the VAD to indicate whether or not speech is detected. This determination may be based on an analysis of the power or energy present in the acoustic signal received by the microphone. The power in the acoustic signal may be compared to a threshold that indicates that speech is present. In another embodiment, the VADm signal indicating speech is computed using the normalized cross-correlation between any pair of the microphone signals (e.g., 121₁ and 121_{M}). If the cross-correlation has values exceeding a threshold within a short delay interval the VADm indicates that the speech is detected. In some embodiments, the VADm is a binary output that is generated as a voice activity detector (VAD), wherein 1 indicates that the speech has been detected in the acoustic signals and 0 indicates that no speech has been detected in the acoustic signals.

Both the VADa and the VADm may be subject to erroneous detections of voiced speech. For instance, the VADa may falsely identify the movement of the user or the headset 100 as being vibrations of the vocal chords while the VADm may falsely identify noises in the environment as being speech in the acoustic signals. Accordingly, in one embodiment, the VAD output (VADv) is set to indicate that the user's voiced speech is detected (e.g., VADv output is set to 1) if the coincidence between the detected speech in acoustic signals (e.g., VADm) and the user's speech vibrations from the accelerometer data output signals is detected (e.g., VADa). Conversely, the VAD output is set to indicate that the user's voiced speech is not detected (e.g., VADv output is set to 0) if this coincidence is not detected. In other words, the VADv output is obtained by applying an AND function to the VADa and VADm outputs.

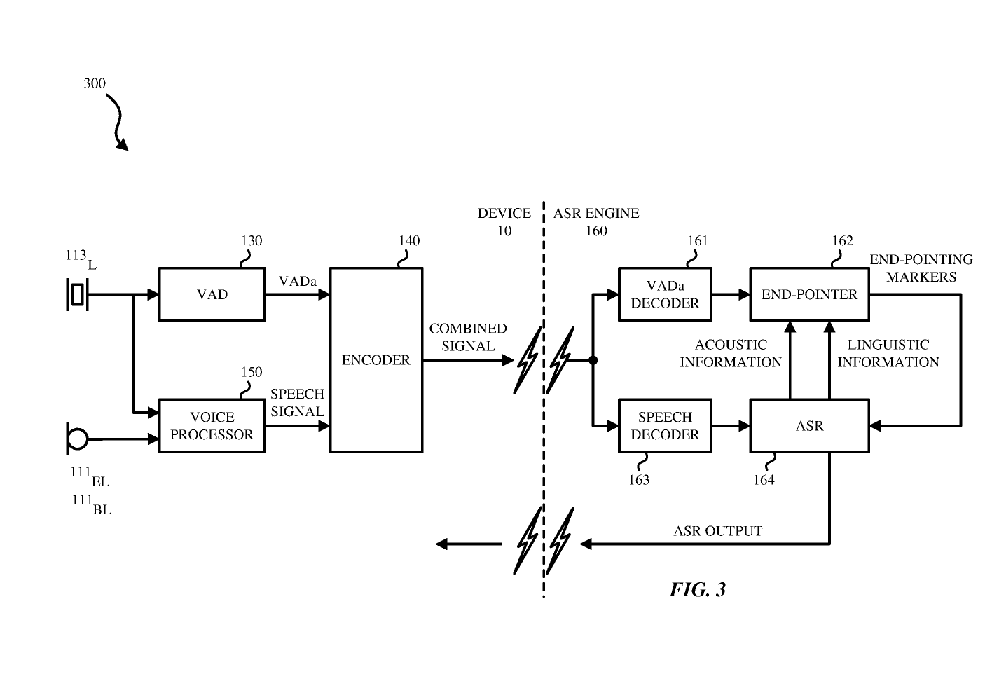

FIG. 3 illustrates a block diagram of a system 300 for performing automatic speech recognition (ASR) using end-pointing markers generated using accelerometer-based voice activity detector according to an embodiment.

As shown in FIG. 3, the system 300 includes the electronic device 10 and an ASR engine 160. In some embodiments, the ASR engine 160 is included in a server that is separate from the electronic device 10. By having the ASR engine 160 included in a server, the ASR engine 160 may be more powerful and more adaptive. In other embodiments, the ASR engine 160 is included in an electronic device (e.g., laptop) that is separate from electronic device 10 (e.g., smart phone). The device 10 may communicate wirelessly with the ASR engine 160.

In FIG. 3, the electronic device 10 includes one accelerometer 113_{L} and one microphone 111_{EL} or 111_{BL}. While the system 300 in FIG. 3 includes only one accelerometer 113_{L} and one microphone 111_{EL} or 111_{BL}, it is understood that at least one of the accelerometers (e.g., 113_{L}, 113_{R}) and at least one of the microphones in the headset 100 (e.g., 111_{BR}, 111_{BL}, 111_{ER}, 111_{EL} or the microphone array 121₁-121_{M}) may be included in the system 300.

The electronic device 10 also includes a voice activity detector (VAD) 130 that generates an accelerometer VAD output (VADa) based on data output by the at least one accelerometer 113_{L}. As shown in FIG. 3, the VAD 130 receives the accelerometer's 113_{L} signals that provide information on sensed vibrations in the x, y, and z directions.

The accelerometer data output signals (or accelerometer signals) may be first pre-conditioned. First, the accelerometer signals are pre-conditioned by removing the DC component and the low frequency components by applying a high pass filter with a cut-off frequency of 60 Hz-70 Hz, for example. Second, the stationary noise is removed from the accelerometer signals by applying a spectral subtraction method for noise suppression. Third, the cross-talk or echo introduced in the accelerometer signals by the speakers in the earbuds may also be removed. This cross-talk or echo suppression can employ any known methods for echo cancellation. Once the accelerometer signals are pre-conditioned, the VAD 130 may use these signals to generate the VADa output. In one embodiment, the VADa output is generated by using one of the X, Y, and Z accelerometer signals which shows the highest sensitivity to the user's speech or by adding the three accelerometer signals and computing the power envelope for the resulting signal. When the power envelope is above a given threshold, the VADa output is set to 1, otherwise is set to 0. In another embodiment, the VADa output indicating voiced speech is computed using the normalized cross-correlation between any pair of the accelerometer signals (e.g. X and Y, X and Z, or Y and Z). If the cross-correlation has values exceeding a threshold within a short delay interval the VADa output indicates that the voiced speech is detected. In another embodiment, a combined VAD output is generated by computing the coincidence as a “AND” function between the VADm from one of the microphone signals or beamformer output and the VADa from one or more of the accelerometer signals (VADa). This coincidence between the VADm from the microphones and the VADa from the accelerometer signals ensures that the VAD is set to 1 only when both signals display significant correlated energy, such as the case when the user is speaking. In another embodiment, when at least one of the accelerometer signal (e.g., X, Y, or Z signals) indicates that user's speech is detected and is greater than a required threshold and the acoustic signals received from the microphones also indicates that user's speech is detected and is also greater than the required threshold, the VAD output is set to 1, otherwise is set to 0. In some embodiments, an exponential decay function and a smoothing function are further applied to the VADa output.

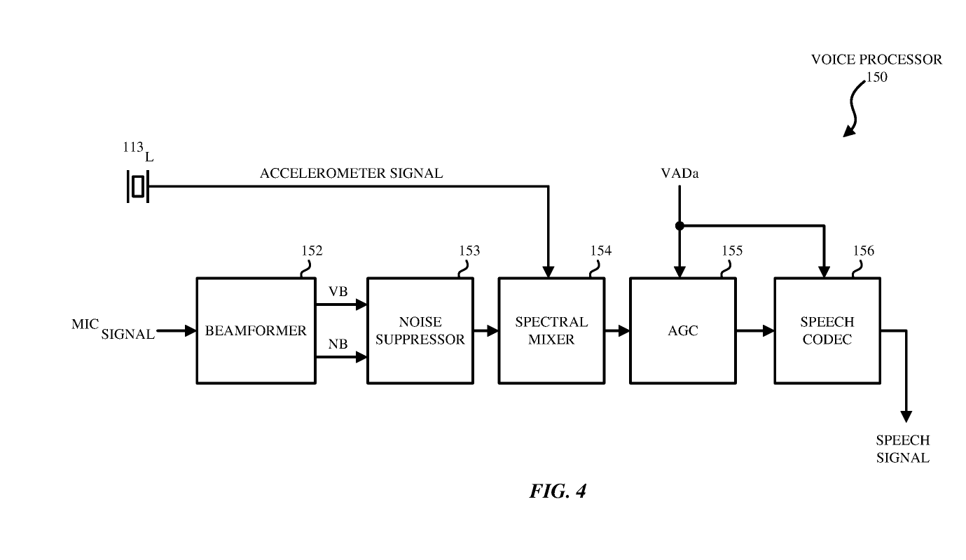

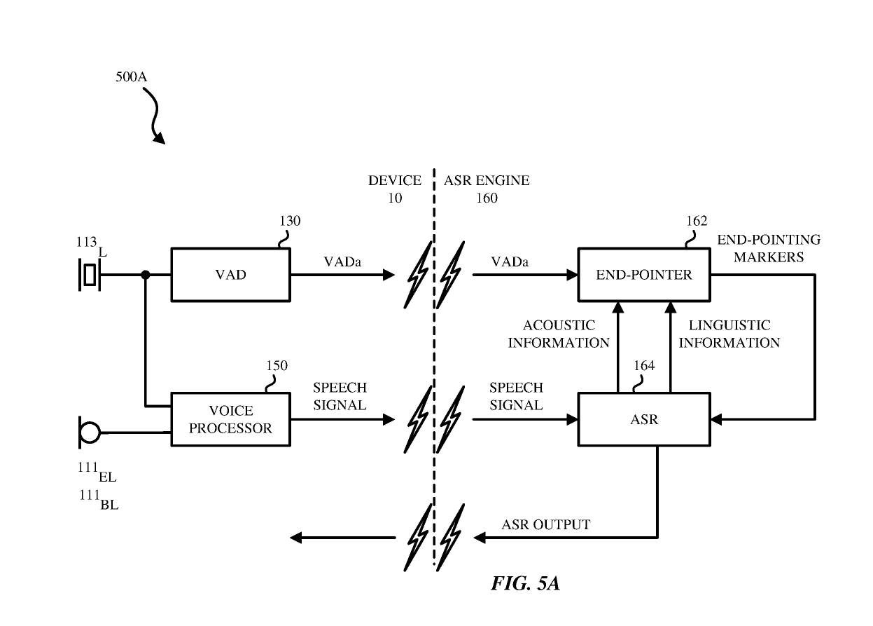

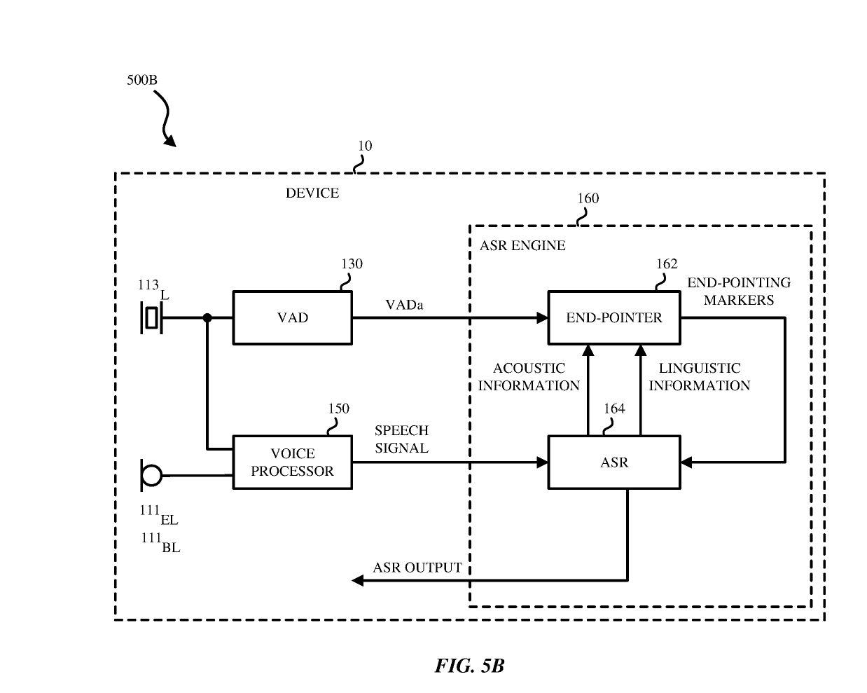

Referring back to FIG. 3, the electronic device 10 also includes a voice processor 150 that generates a speech signal based on the acoustic signals from the at least one microphone 111_{EL}, 111_{BL}. The acoustic signals may include, for example, a speech query uttered by the user of the electronic device 10 to be processed by the ASR engine 160. In FIG. 4, a block diagram illustrates the details of the voice processor 150 included in FIG. 3 (and FIGS. 5-7) for performing automatic speech recognition (ASR) using end-pointing markers generated using accelerometer-based voice activity detector according to one embodiment.

The voice processor 150 may include a beamformer 152, a noise suppressor 153, a spectral mixer 154, an AGC controller 155, and a speech codec 156. In some embodiments, the headset 100 is coupled to the electronic device 10 wirelessly and communicates the output of the speech codec 156 to the electronic device 10. In this embodiment, the earbuds 110_{L}, 110_{R} include the beamformer 152, noise suppressor 153, spectral mixer 154, AGC controller 155, and speech codec 156. In other embodiments, the earbuds 110_{L} are coupled to the electronic device 10 via the headset wire 120 and the electronic device 10 includes the beamformer 152, noise suppressor 153, spectral mixer 154, AGC controller 155, and speech codec 156.

The beamformer 152 receive the acoustic signals from at least one of the microphones 111_{BL} and 111_{EL} as illustrated in FIG. 3. The beamformer 152 may be directed or steered to the direction of the user's mouth to provide an enhanced speech signal.

In one embodiment, the VADa output may be used to steer the beamformer 152. For example, when the VADa output is set to 1, one microphone in one of the earbuds 110_{L}, 110_{R} may detect the direction of the user's mouth and steer a beamformer in the direction of the user's mouth to capture the user's speech while another microphone in one of the earbuds 110_{L}, 110_{R} may steer a cardioid or other beamforming patterns in the opposite direction of the user's mouth to capture the environmental noise with as little contamination of the user's speech as possible. In this embodiment, when the VADa output is set to 0, one or more microphones in one of the earbuds 110_{L}, 110_{R} may detect the direction and steer a second beamformer in the direction of the main noise source or in the direction of the individual noise sources from the environment.

In the embodiment illustrated in FIG. 1, the user in the left part of FIG. 1 is speaking while the user in the right part of FIG. 1 is not speaking. When the VAD output is set to 1, at least one of the microphones in the headset 100 is enabled to detect the direction of the user's mouth. The same or another microphone in the headset 100 creates a beamforming pattern in the direction of the user's mouth, which is used to capture the user's speech. Accordingly, the beamformer outputs an enhanced speech signal. When the VADa output is 0, the same or another microphone in the headset 100 may create a cardioid beamforming pattern or other beamforming patterns in the direction opposite to the user's mouth, which is used to capture the environmental noise. When the VADa output is 0, other microphones in the headset 100 may create beamforming patterns (not shown in FIG. 1) in the directions of individual environmental noise sources. When the VADa output is 0, the microphones in the headset 100 is not enabled to detect the direction of the user's mouth, but rather the beamformer is maintained at its previous setting. In this manner, the VADa output is used to detect and track both the user's speech and the environmental noise. The microphones in the headset 100 are generating beams in the direction of the mouth of the user in the left part of FIG. 1 to capture the user's speech (voice beam) and in the direction opposite to the direction of the user's mouth in the right part of FIG. 1 to capture the environmental noise (noise beam).

Referring back to FIG. 3, using the beamforming methods described above, the beamformer 152 generates a voice beam signal (VB) and a noise beam signal (NB) that are output to the noise suppressor 153. In some embodiments, the voice beam signal is used by the VAD to generate a VADm output as discussed above (not shown).

The noise suppressor 153 may be a 2-channel noise suppressor that can perform adequately for both stationary and non-stationary noise estimation. In one embodiment, the noise suppressor 153 includes a two-channel noise estimator that produces noise estimates that are noise estimate vectors, where the vectors have several spectral noise estimate components, each being a value associated with a different audio frequency bin. This is based on a frequency domain representation of the discrete time audio signal, within a given time interval or frame.

The noise suppressor 153 then uses the output noise estimate generated by the two-channel noise estimator to attenuate the voice beam signal. The action of the noise suppressor 153 may be in accordance with a conventional gain versus SNR curve, where typically the attenuation is greater when the noise estimate is greater. The attenuation may be applied in the frequency domain, on a per frequency bin basis, and in accordance with a per frequency bin noise estimate which is provided by the two-channel noise estimator. The noise suppressed voice beam signal (e.g., clean beamformer signal) is then outputted to the spectral mixer 154.

The spectral mixer 154 may receive (i) the accelerometer signal (e.g., from at least one accelerometer 113_{L}) and (ii) the clean beamformer signal (e.g., the noise suppressed or de-noised beamformer signal). The spectral mixer 154 performs spectral mixing of the received signals to generate a mixed signal. In one embodiment, the spectral mixer 154 generates a mixed signal that includes the accelerometer signal to account for the low frequency band (e.g., 800 Hz and under) of the mixed signal, and the clean beamformer signal to account for the high frequency band (e.g., over 4000 Hz).

The AGC controller 155 receives the mixed signal from the spectral mixer 154 and performs AGC on the mixed signal based on the VADa output received from the VAD 130. The speech codec 156 receives the AGC output from the AGC controller 155 and performs encoding on the AGC output based on the VADa output from the VAD 130. The speech codec may generate a speech signal.

Referring back to FIG. 3, the electronic device 10 includes an encoder 140 that receives the VADa output from VAD 130 and the speech signal from the voice processor 150. The encoder 140 may perform encoding to generate a combined signal based on the VADa output and the speech signal. The combined signal may include the information in the VADa output and the speech signal. In some embodiments, encoding includes changing the format of the VADa output and the speech signal to reduce the bit rate required or to make it more efficient for transmission as a wireless signal to the ASR engine 160. In some embodiments, the encoder 140 combines the VADa output and the speech signal in frequency domain. The encoding may be based on embedding a sinusoidal signal of for example 50 Hz (e.g., when VADa output indicates speech is detected) into the lower part of the spectrum of the speech query (e.g., speech signal) and allowing for the speech query to occupy the spectra above 100 Hz. In some embodiments, the encoder 140 may encode the VADa output and the speech signal per frame. The frames may be different sized frames (e.g., 5-20 ms).

In FIG. 3, the ASR engine 160 receives the combined signal from the electronic device 10. The electronic device 10 may transmit the combined signal wirelessly over a network to the ASR engine 160 which may be included in a server. The ASR engine 160 includes a VADa decoder 161, an end-pointer 162, a speech decoder 163 and an ASR module 164.

The VADa decoder 161 and the speech decoder 163 receive and decode the encoded combined signal to respectively obtain a decoded VADa output and a decoded speech signal. In one embodiment, the VADa decoder 161 may pass the combined signal through a Low Pass filter and the speech decoder 163 may pass the combined signal through a High Pass filter. In one embodiment, both filters may have a cutoff frequency of about 80 Hz. The VADa decoder 161 may detect if in each frame of 10 ms, for example, there is either a positive or a negative semi-sinusoid. If the VADa decoder 161 detects either the positive or the negative semi-sinusoid, then the VADa decoder 161 generates the decoded VADa output that indicates that voice activity is detected, otherwise, the VADa decoder 161 generates the decoded VADa output that indicates that voice activity is not detected.

The decoded VADa output is provided to the end-pointer 162 which is a server-side endpointer in system 300. The end-pointer 162 may include a Deep Neural Network (DNN). The end-pointer 162 generates end-pointing markers (e.g., indicating beginning and ending of the user or primary speaker's utterance) based on the decoded VADa output from the VADa decoder 161. The ASR module 164 may generate acoustic and linguistic information during the decoding process from the acoustic model and the linguistic model that is transmitted to the end-pointer 162. In one embodiment, the end-pointer 162 generates end-pointing markers based on the VADa output and the acoustic and linguistic information that is received from the ASR module 164. The ASR module 164 may perform ASR on the speech signal based on the end-pointing markers received from the end-pointer 162. The ASR module 164 may be implemented to have a front-end DNN. The ASR module 164 may generate an ASR output that is transmitted back to the electronic device 10 wirelessly. The ASR output may include the text of the speech signal.

FIGS. 5A and 5B illustrate block diagrams of systems 500A and 500B for performing automatic speech recognition (ASR) using end-pointing markers generated using accelerometer-based voice activity detector according to embodiments of the present disclosure. Similar to FIG. 3, in FIG. 5A, the ASR engine 160 may be included in a server that is separate from the electronic device 10. In other embodiments, the ASR engine 160 is included in an electronic device (e.g., laptop) that is separate from electronic device 10 (e.g., smart phone). The device 10 and ASR engine 160 may communicate wirelessly. While the system 500A in FIG. 5A includes only one accelerometer 113_{L} and one microphone 111_{EL} or 111_{BL}, it is understood that at least one of the accelerometers (e.g., 113_{L}, 113_{R}) and at least one of the microphones in the headset 100 (e.g., 111_{BR}, 111_{BL}, 111_{ER}, 111_{EL} or the microphone array 121₁-121_{M}) may be included in the system 500.

Contrary to system 300 in FIG. 3, in the system 500A of FIG. 5A, the electronic device 10 does not include the encoder 140 but rather transmits wirelessly the VADa output from VAD 130 and the speech signal from voice processor 150 separately to the ASR engine 160. Since the VADa output and the speech signal are not encoded, the ASR engine 160 in FIG. 5A does not include VADa decoder 161 and speech decoder 163. Instead, in system 500A, end-pointer 162 receives the VADa output from the electronic device 10 and the ASR module 164 receives the speech signal from the electronic device 10.

In the embodiment in FIG. 5B, the system 500B includes an ASR engine 160 that is included in the electronic device 10 (e.g., mobile device). While the system 500B in FIG. 5B includes only one accelerometer 113_{L} and one microphone 111_{EL} or 111_{BL}, it is understood that at least one of the accelerometers (e.g., 113_{L}, 113_{R}) and at least one of the microphones in the headset 100 (e.g., 111_{BR}, 111_{BL}, 111_{ER}, 111_{EL} or the microphone array 121₁-121_{M}) may be included in the system 500.

In system 500B, the electronic device 10 includes VAD 130 that generates a VADa output based on data output by the at least one accelerometer 113_{L}. The electronic device 10 in FIG. 5B also includes a voice processor 150 that generates a speech signal based on the acoustic signals from the at least one microphone 111_{EL}, 111_{BL}. The acoustic signals may include, for example, a speech query uttered by the user of the electronic device 10 to be processed by the ASR engine 160.

The VADa output is provided to the end-pointer 162 which is included in the ASR engine 160 that is also included in the electronic device 10 in system 500B. The end-pointer 162 may include a Deep Neural Network (DNN)). The end-pointer 162 generates end-pointing markers (e.g., indicating beginning and ending of the user or primary speaker's utterance) based on the VADa output. The ASR module 164 may generate acoustic and linguistic information during the decoding process from the acoustic model to the linguistic model that is transmitted to the end-pointer 162. In one embodiment, the end-pointer 162 generates end-pointing markers based on the VADa output and the acoustic and linguistic information that is received from the ASR module 164. The ASR module 164 may perform ASR on the speech signal based on the end-pointing markers received from the end-pointer 162. The ASR module 164 may be implemented to have a front-end DNN. The ASR module 164 may generate an ASR output that is further processed by the electronic device 10. For example, the ASR output may include the text of the speech signal that the electronic device 10 displays on the device 10's display device (e.g., touch screen or display screen).

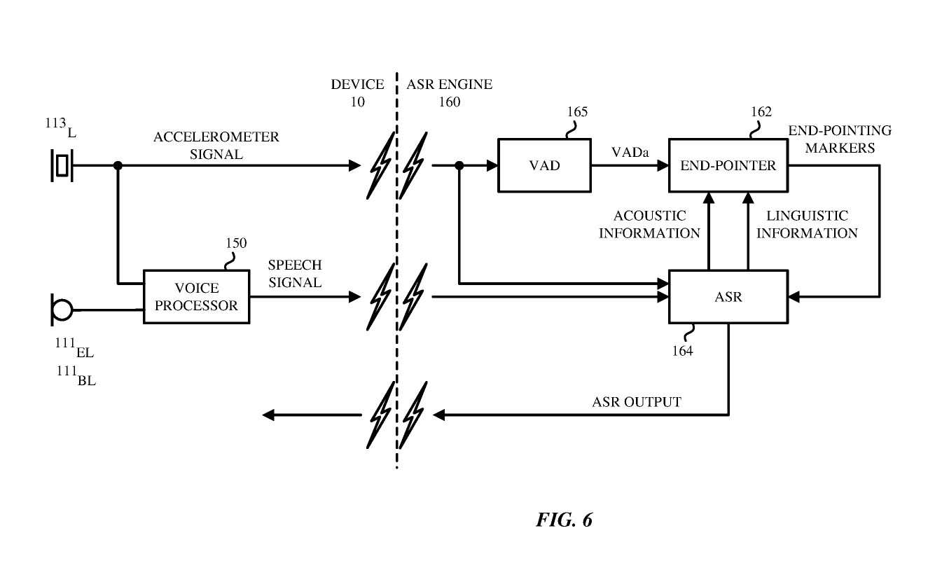

FIG. 6 illustrates a block diagram of a system 600 for performing automatic speech recognition (ASR) using end-pointing markers generated using accelerometer-based voice activity detector according to an embodiment. Similar to FIG. 5, in FIG. 6, the ASR engine 160 may be included in a server that is separate from the electronic device 10. In other embodiments, the ASR engine 160 is included in an electronic device (e.g., laptop) that is separate from electronic device 10 (e.g., smart phone). The device 10 and ASR engine 160 may communicate wirelessly. While the system 600 in FIG. 6 includes only one accelerometer 113_{L} and one microphone 111_{EL} or 111_{BL}, it is understood that at least one of the accelerometers (e.g., 113_{L}, 113_{R}) and at least one of the microphones in the headset 100 (e.g., 111_{BR}, 111_{BL}, 111_{ER}, 111_{EL} or the microphone array 121₁-121_{M}) may be included in the system 600.

Contrary to FIG. 5, the electronic device 10 in FIG. 6 does not include the VAD 130. Instead, the data output by the at least one accelerometer 113_{L} (e.g., accelerometer signal) is transmitted wirelessly from the electronic device 10 to the ASR engine 160. The ASR engine 160 in FIG. 6 includes the VAD 165 that receives the data output by the at least one accelerometer from the electronic device 10 and generates an accelerometer VAD output (VADa) based on data output by the at least one accelerometer. Accordingly, the VADa output may be computed on the server side of system 600.

In another embodiment, the accelerometer signal received by the ASR engine 160 may also be received by the ASR module 164. In this embodiment, the accelerometer signal can be applied as a secondary input to the ASR module 164. Based on the accelerometer signal, the speech signal, and the end-pointing markers, the ASR module 164 in this embodiment performs ASR and generates an ASR output.

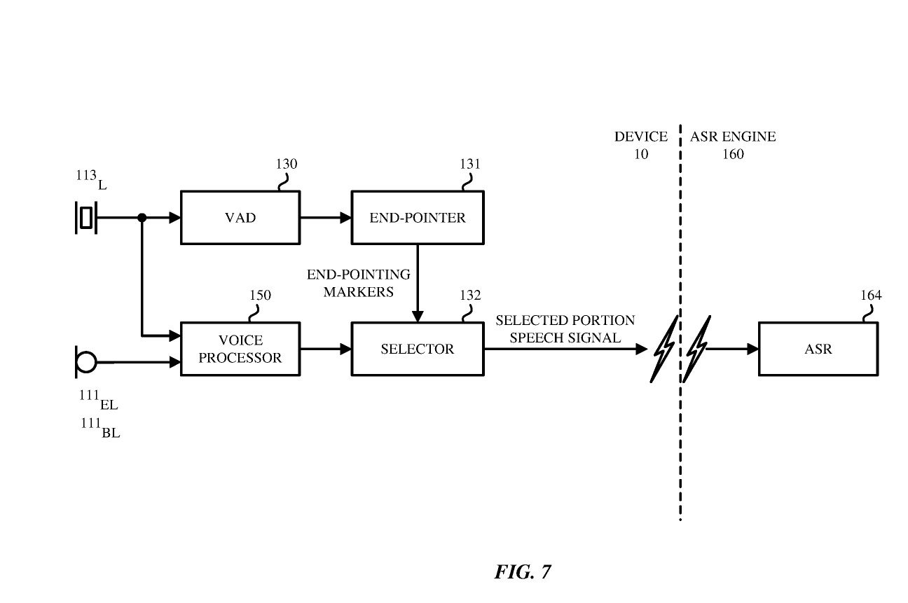

FIG. 7 illustrates a block diagram of a system 700 for performing automatic speech recognition (ASR) using end-pointing markers generated using accelerometer-based voice activity detector according to an embodiment. Similar to FIG. 5, in FIG. 7, the ASR engine 160 may be included in a server that is separate from the electronic device 10. In other embodiments, the ASR engine 160 is included in an electronic device (e.g., laptop) that is separate from electronic device 10 (e.g., smart phone). The device 10 and ASR engine 160 may communicate wirelessly. While the system 700 in FIG. 7 includes only one accelerometer 113_{L} and one microphone 111_{EL} or 111_{BL}, it is understood that at least one of the accelerometers (e.g., 113_{L}, 113_{R}) and at least one of the microphones in the headset 100 (e.g., 111_{BR}, 111_{BL}, 111_{ER}, 111_{EL} or the microphone array 121₁-121_{M}) may be included in the system 700.

Contrary to the system in FIG. 5, the electronic device 10 in FIG. 7 includes the end-pointer 131 and a selector 132. The end-pointer 131 that is on the device-side receives the VADa output from the VAD 130 and determines the beginning and end of the utterances to generate the end-pointing markers based on the VADa output. The selector 132 receives the speech signal from the voice processor 150 and the end-pointing markers from the end-pointer 131. The selector 132 selects a portion of the speech signal based on the end-point markers to transmit wirelessly to the ASR engine 160. The selector 132 may also transmit the portion of the speech signal to the ASR engine 160. The ASR module 164 included in the ASR engine 160 performs ASR on the portion of the speech signal received from the electronic device 10 to generate the ASR output that is transmitted wirelessly back to the electronic device 10.

The following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

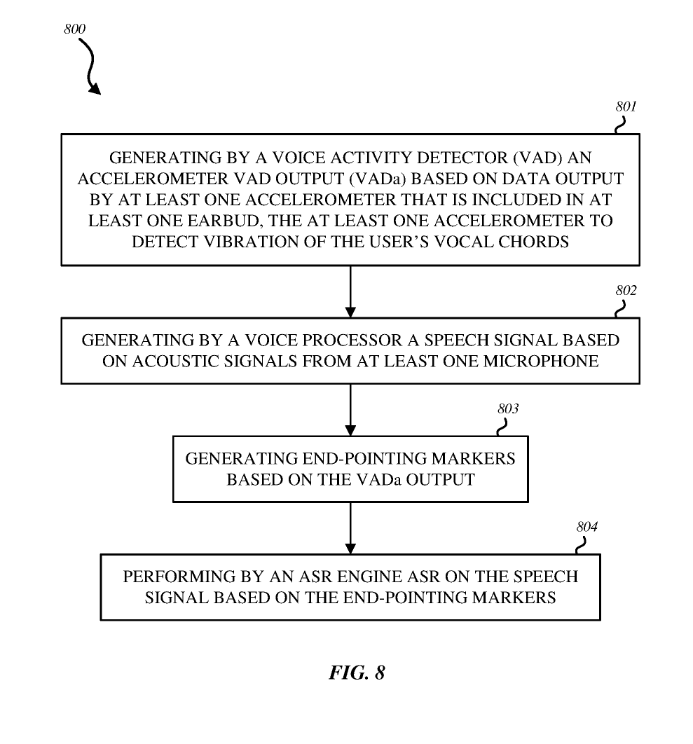

FIG. 8 illustrates a flow diagram of an example method 800 of performing automatic speech recognition (ASR) using end-pointing markers generated using accelerometer-based voice activity detector according to one embodiment.

The method 800 starts, at Block 801, with a voice activity detector (VAD) generating an accelerometer VAD output (VADa) based on data output by at least one accelerometer that is included in at least one earbud. The at least one accelerometer detects vibration of the user's vocal chords. In one embodiment, the VAD is included in an ASR engine included in a server. In this embodiment, the electronic device transmits the data output by the at least one accelerometer to the ASR engine and the ASR engine computes the VADa output using the server side VAD. In another embodiment, the VAD is included in an electronic device. In this embodiment, the VADa output is generated by the device-side VAD and transmitted to the ASR engine.

At Block 802, a voice processor generates a speech signal based on acoustic signals from at least one microphone. The voice processor may be included in the electronic device. In one embodiment, the VADa output generated by the VAD included in the electronic device and the speech signal from the voice processor are encoded by an encoder included in the electronic device. The ASR engine in this embodiment then decodes the combined signal to obtain a decoded VADa output and a decoded speech signal.

At Block 803, an end-pointer generates the end-pointing markers based on the VADa output. In one embodiment, the end-pointer is included in the ASR engine. The ASR engine may be included on a server.

At Block 804, an ASR engine performs ASR on the speech signal based on the end-pointing markers. In one embodiment, the ASR module included in the ASR engine generates acoustic and linguistic information. In this embodiment, the end-pointer may generate the end-pointing markers based on the decoded VADa output and the acoustic and linguistic information from the ASR module.

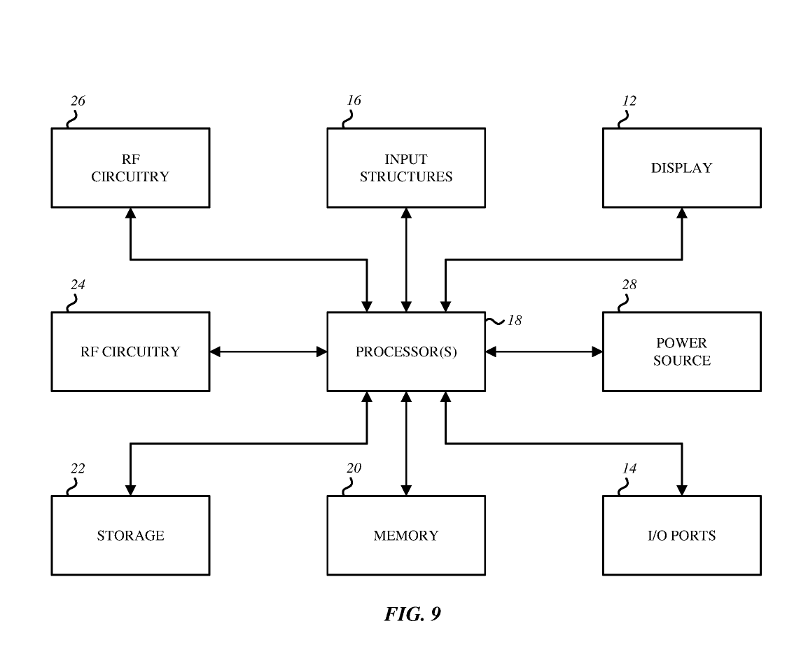

FIG. 9 is a block diagram of exemplary components of an electronic device 10 included in the system in FIGS. 3 and 5-7 for performing automatic speech recognition (ASR) using end-pointing markers generated using accelerometer-based voice activity detector in accordance with aspects of the present disclosure. Specifically, FIG. 9 is a block diagram depicting various components that may be present in electronic devices suitable for use with the present techniques. The electronic device 10 may be in the form of a computer, a handheld portable electronic device such as a cellular phone, a mobile device, a personal data organizer, a computing device having a tablet-style form factor, etc. These types of electronic devices, as well as other electronic devices providing comparable voice communications capabilities (e.g., VoIP, telephone communications, etc.), may be used in conjunction with the present techniques.

Keeping the above points in mind, FIG. 9 is a block diagram illustrating components that may be present in one such electronic device 10, and which may allow the device 10 to function in accordance with the techniques discussed herein. The various functional blocks shown in FIG. 9 may include hardware elements (including circuitry), software elements (including computer code stored on a computer-readable medium, such as a hard drive or system memory), or a combination of both hardware and software elements. It should be noted that FIG. 9 is merely one example of a particular implementation and is merely intended to illustrate the types of components that may be present in the electronic device 10. For example, in the illustrated embodiment, these components may include a display 12, input/output (I/O) ports 14, input structures 16, one or more processors 18, memory device(s) 20, non-volatile storage 22, expansion card(s) 24, RF circuitry 26, and power source 28.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

1. A method of performing automatic speech recognition (ASR) using end-pointing markers generated using an accelerometer-based voice activity detector comprising:
generating, by a voice activity detector (VAD), an accelerometer VAD output (VADa) based on data output by at least one accelerometer that is included in at least one earbud, the at least one accelerometer to detect vibration of the user's vocal chords;
generating, by a voice processor, a speech signal based on acoustic signals from at least one microphone;
generating, by an end-pointer, the end-pointing markers based on the VADa output; and
performing, by an ASR engine, ASR on the speech signal based on the end-pointing markers.

2. The method of claim 1, wherein an electronic device includes the VAD, the voice processor, and the ASR engine.

3. The method of claim 1, wherein
the VAD and the voice processor are included in an electronic device,
the ASR engine is included in a server that is separate from the electronic device, wherein the ASR engine includes the end-pointer.

4. The method of claim 3, further comprising:
encoding the VADa output and the speech signal to generate a combined signal; and
decoding, by the ASR engine, the combined signal to obtain a decoded VADa output and a decoded speech signal.

5. The method of claim 4, further comprising:
generating acoustic and linguistic information by an ASR module in the ASR engine;
generating, by the end-pointer, end-pointing markers based on the decoded VADa output and the acoustic and linguistic information, wherein the end-pointer is included in the ASR engine; and
performing by the ASR module ASR based on the end-pointing markers and the decoded speech signal.

6. The method of claim 1, wherein
the voice processor is included in an electronic device,
the ASR engine is included in a server that is separate from the electronic device, the ASR engine including the end-pointer and the VAD.

7. The method of claim 6, further comprising:
transmitting by the electronic device the speech signal from the voice processor and the data output by the at least one accelerometer wirelessly to the server.

8. The method of claim 1, wherein
the VAD, the voice processor, and the end pointer are included in an electronic device, and
the ASR engine is included in a server that is separate from the electronic device.

9. The method of claim 8, further comprising:
selecting by a selector included in the electronic device a portion of the speech signal based on the end-point markers, and
transmitting by the electronic device the portion of the speech signal wireles sly to the server.

10. A system for performing automatic speech recognition (ASR) using end-pointing markers generated using an accelerometer-based voice activity detector comprising:
an electronic device including:
at least one accelerometer that is included in at least one earbud, the at least one accelerometer to detect vibration of the user's vocal chords,
at least one microphone to receive acoustic signals,
a voice activity detector (VAD) generating an accelerometer VAD output (VADa) based on data output by the at least one accelerometer, and
a voice processor generating a speech signal based on the acoustic signals from the at least one microphone; and
a server including an ASR engine that is separate from the electronic device, the ASR engine including:
an end-pointer generating the end-pointing markers based on the VADa output, and
an ASR module performing ASR on the speech signal based on the end-pointing markers.

11. The system of claim 10, wherein
the ASR module included in the ASR engine generates acoustic and linguistic information,
wherein the end-pointer generates end-pointing markers based on the VADa output and the acoustic and linguistic information, and wherein the ASR module performs ASR based on the end-pointing markers and the speech signal.

12. The system of claim 10, wherein the electronic device further comprises
an encoder performing encoding to generate a combined signal based on the VADa output and the speech signal.

13. The system of claim 12, wherein the ASR engine further comprises:
a VADa decoder and a speech decoder decoding the encoded combined signal to respectively obtain a decoded VADa output and a decoded speech signal.

14. The system of claim 13, wherein the electronic device transmits the combined signal wireles sly to the server.

15. The system of claim 13, wherein
the ASR module included in the ASR engine generates acoustic and linguistic information, wherein the end-pointer generates end-pointing markers based on the decoded VADa output and the acoustic and linguistic information, and wherein the ASR module performs ASR based on the end-pointing markers and the decoded speech signal.

16. A system for performing automatic speech recognition (ASR) using end-pointing markers generated using accelerometer-based voice activity detector comprising:
a server including an ASR engine that is separate from an electronic device, the ASR engine including:
a voice activity detector (VAD) generating an accelerometer VAD output (VADa) based on data output by at least one accelerometer, wherein the data output by the at least one accelerometer is received from the electronic device,
an end-pointer generating the end-pointing markers based on the VADa output, and
an ASR module performing ASR on the speech signal based on the end-pointing markers.

17. The system of claim 16, wherein the electronic device includes:
at least one accelerometer that is included in at least one earbud, the at least one accelerometer to detect vibration of the user's vocal chords, and
a voice processor generating a speech signal based on acoustic signals from at least one microphone.

18. The system of claim 17, wherein
the server wireles sly receives the speech signal from the voice processor and the data output by the at least one accelerometer.

19. The system of claim 18, wherein
the ASR module included in the ASR engine generates acoustic and linguistic information,
wherein the end-pointer generates end-pointing markers based on the VADa output and the acoustic and linguistic information, and wherein the ASR module performs ASR based on the end-pointing markers and the speech signal.

20. A system for performing automatic speech recognition (ASR) using end-pointing markers generated using accelerometer-based voice activity detector comprising:
an electronic device including:
at least one accelerometer that is included in at least one earbud, the at least one accelerometer to detect vibration of the user's vocal chords,
at least one microphone to receive acoustic signals,
a voice activity detector (VAD) generating an accelerometer VAD output (VADa) based on data output by the at least one accelerometer,
a voice processor generating a speech signal based on the acoustic signals from the at least one microphone, and
an end-pointer generating the end-pointing markers based on the VADa output, and
a selector selecting a portion of the speech signal based on the end-point markers and transmitting the portion of the speech signal.

21. The system of claim 20, wherein a server including an ASR engine that is separate from the electronic device receives and performs ASR on the portion of the speech signal.

22. The system of claim 21, wherein the electronic device transmits the portion of the speech signal wireles sly to the server.
